(19) United States
(12) Patent Application Publication
(10) Pub. No.: US 2019/0332661 A1
(43) Pub. Date: Oct. 31, 2019

(54) PRE-FILLING PROPERTY AND PERSONAL INFORMATION

(71) Applicant: Hippo Analytics Inc. dba Hippo Insurance Services, Mountain View, CA (US)

(72) Inventors: Ran Israel Halprin Limor, Sunnyvale, CA (US); Aviad Pinkovezky, Mountain View, CA (US); Eyal Navon, Sunnyvale, CA (US); Assaf Wand, Palo Alto, CA (US)

(21) Appl. No.: 15/963,763

(22) Filed: Apr. 26, 2018

(51) Int. Cl. G06F 17/24; G06Q 30/02; G06Q 40/08

(52) U.S. Cl. CPC G06F 17/243; G06Q 40/08; G06F 17/248; G06Q 30/0283

(57) ABSTRACT

A technique for automating the process of populating certain data fields of a customer survey. The techniques include backend processes and architectures that allow for the retrieval, modeling, and population of certain data fields during the customer evaluation process as during the process of requesting a quote for products or services. The process includes receiving identifying information for property and using the property identifying information to request additional data about the property from at least one source of property information. The responses are normalized to a predetermined data format and mapped to predetermined fields of a pre-fill template which is then presented to a user's display device as a part of the customer survey. Data conflicts from the information sources are resolved using preestablished business rules determining which information source has priority and the pre-fill template is updated from the information source having priority.

### TECHNICAL FIELD

The subject matter disclosed herein generally relates to an electronic communications platform that facilitates online insurance and loan applications and, in particular, to an electronic communications platform that automatically pre-fills property and personal information from online information sources into insurance and loan applications to ensure consistency and accuracy of data across multiple data input fields.

### BACKGROUND

The process of obtaining insurance on property or collateralizing a loan requires the agent to collect information from a potential customer about the customer and, in the case of insurance or a loan on property such as a home, information about the home. Whether the insurance or loan application is submitted online or in person, the process requires the potential customer to provide the personal information and the property information in an application that is then used to obtain a quote. Typically, the customer must provide to the agent 20-30 items of information about the property alone, in addition to the information about the customer. For example, in the case of insurance on a home, the customer is asked to provide the address of the home, the roof and wall materials, when the roof was last replaced, square footage, when built, and the like. Once the application has been completed, the insurance or loan company must validate the information, which may require one or more follow-up conversations with the potential customer to collect missing information and to correct erroneous information. In many cases, the information relating to the property to be insured is unknown to the potential customer and must be looked up through the appropriate information sources. Generally, whether this process is performed in person, on paper, or online, the back and forth with the agent required to obtain the requisite information and then obtaining a quote may take several days or even weeks. The agent would then need to use standard information sources to supplement the provided information with other information (e.g., distance to the nearest fire station), to validate the provided information, to obtain policy information, and then to generate a quote for the insurance policy or loan to be offered. The policy or loan is then reviewed and offered to the customer.

It is desirable to use computer technology to speed up this process to provide a user-friendly, sleek experience in which an insurance or loan quote is provided in minutes, or even seconds. Since a quote is only as reliable as the information upon which it is based, one may not simply feed information into a computer and obtain a reliable quote. On the contrary, there are several technical hurdles to speeding up such a process. For example, the customer information must be captured and validated very quickly even for information that is not readily known by the potential customer. Also, in order to be reliable, the quote must be based on consistent information. This is difficult as the information used for insurance and loan quotes is not available in a standardized format anywhere on the Internet. Also, while it is desirable to compare information from different information sources to confirm facts and figures, information from different information sources often conflicts, creating further difficulties. For these and other reasons, the process of automating the process of obtaining insurance and loan quotes quickly and accurately has proven to be very difficult.

### SUMMARY OF THE EMBODIMENTS

The systems and methods described herein address the afore-mentioned and other needs in the art by providing an electronic communications platform that pre-fills property and personal information into insurance applications from information available online for expedited completion and approval of insurance and loan applications. The information is obtained from a parallel pool of relevant information sources and then normalized and mapped to a template in a standard format for obtaining a quote based on the provided information. Logic and business rules are used to enable real-time determinations of which information sources are more reliable, which information may be combined, and what information sources to use when the information is in conflict so that the information mapped to the template may be obtained from the most reliable information sources for each item of information.

In sample embodiments, the communication platform may pre-fill the information needed for completing an insurance application from the address of the property in the case of a home, a vehicle identification number in the case or an automobile, or a product identification in the case of other personal property. The provided information is used to obtain the rest of the data for the insurance application in a manner of seconds. The potential customer may then review the information for accuracy, make any appropriate changes, approve the information to be used for the quote, provide limited personal information, request a quote, and then obtain one or more quotes for selection within minutes or even seconds.

In sample embodiments, a system is provided including a machine-readable medium storing computer-executable instructions and at least one hardware processor communicatively coupled to the machine-readable medium that, when the computer-executable instructions are executed, configures the system to implement a method of pre-filling the information needed for completing a customer survey in connection with requested products and services. Such products and services may include retrieval of loan history, modeling and data packages used to evaluate similarly situated properties, as well as data supporting loan and insurance applications. The instructions executed by the at least one hardware processor cause the at least one hardware processor to implement a process including receiving identifying information for property and using the property identifying information to request additional data about the property from at least one source of property information. Upon receipt of at least one response to the request for additional data about the property from the at least one source of property information, the received data is normalized to a predetermined data format and mapped to predetermined fields of a pre-fill template. A graphical user interface including the updated pre-fill template is then generated for presentation to a user's display device as at least part of the customer survey.

In further sample embodiments, the at least one hardware processor further executes computer-executable instructions to resolve data conflicts in data received from at least two information sources using preestablished business rules determining which information source has priority in the event of a conflict and to provide data to the pre-fill template from the information source having priority. The at least one hardware processor may further execute computer-executable instructions to receive user corrections to data in the updated pre-fill template presented via the graphical user interface and to generate a quote for a product or service using corrected data in the updated pre-fill template. In sample embodiments, the identifying information comprises an address of a home, a vehicle identification number, or a product ID.

In further sample embodiments, requesting additional data about the property includes requesting data from at least two sources of property information in parallel and automatically selecting data to provide in the pre-fill template from the at least two sources of property information using preestablished business rules applied to the at least two sources of property information. The at least one hardware processor may further execute computer-executable instructions to store data from the at least one information source in the pre-fill template as auxiliary data that supports data in the updated pre-fill template presented to the user's display device as at least part of the customer survey.

### BRIEF DESCRIPTION OF THE DRAWINGS

Some embodiments are illustrated by way of example and not limitation in the figures of the accompanying drawings of which:

FIG. 1A illustrates a graphical user interface for initiating the process of generating a pre-filled customer survey for use in obtaining an insurance quote on a home in a sample embodiment.

FIG. 1B illustrates a graphical user interface for selecting the type of home once the address has been provided in a sample embodiment.

FIG. 1C illustrates a graphical user interface presenting pre-filled property information in response to the user's entry of only the address and type of home in a sample embodiment.

FIG. 1D illustrates a graphical user interface for entering information from the potential customer about the home's furnishings.

FIG. 1E illustrates a graphical user interface for entering information identifying the potential customer.

FIG. 1F illustrates a graphical user interface for presenting sample quotes to the potential customer based on the customer information and pre-filled property information in a sample embodiment.

FIG. 1G illustrates a graphical user interface illustrating a quote selected from the options presented in FIG. 1F in a sample embodiment.

FIG. 2 illustrates the architecture of an electronic communications platform that pre-fills property and personal information into insurance and loan applications in accordance with a sample embodiment.

FIG. 3 illustrates a sample architecture for software processes of the quote server of the communications platform of FIG. 2 in a sample embodiment.

FIG. 4 illustrates a timing diagram showing the operation of the respective software components of the quote server in a sample embodiment.

FIG. 5 illustrates the mapping of responses to the pre-fill template in a sample embodiment.

FIG. 6 illustrates an example of the operation of the response parser for identifying information to use to establish the year a home was built in a sample embodiment.

FIG. 7 illustrates an example of normalizing data from different information sources for insertion into the pre-fill template in a sample embodiment.

FIG. 8 illustrates an example of the operation of the field selector for selecting an information source to use in a sample embodiment.

FIG. 9 is a flow diagram illustrating sample operation of the quote server in a sample embodiment.

FIG. 10 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

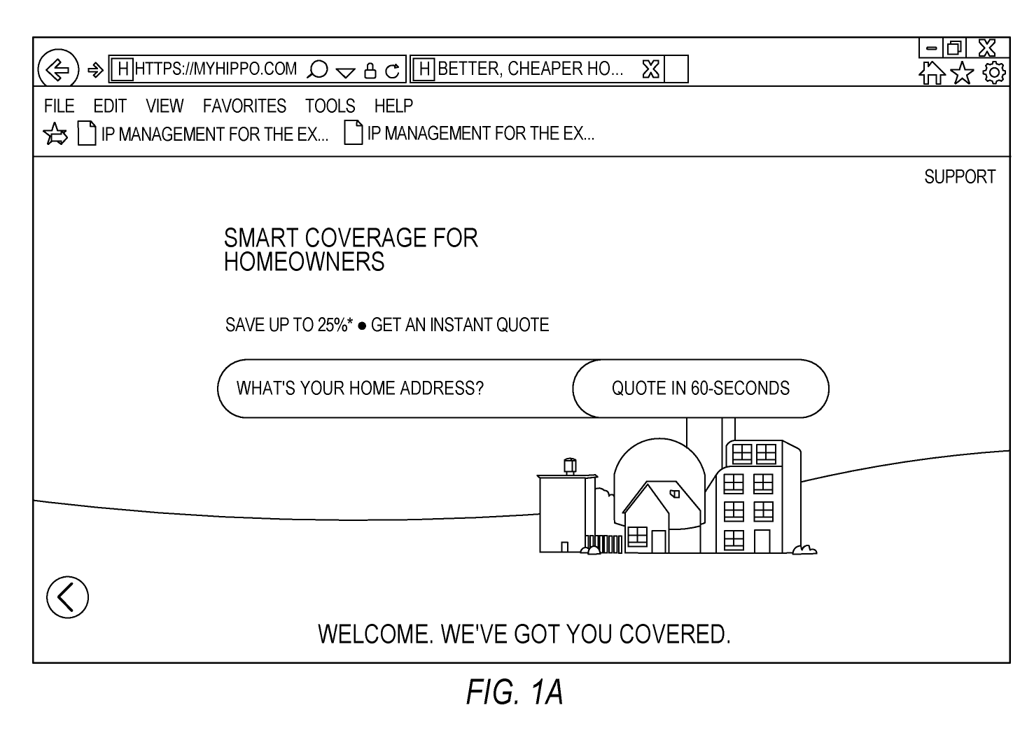

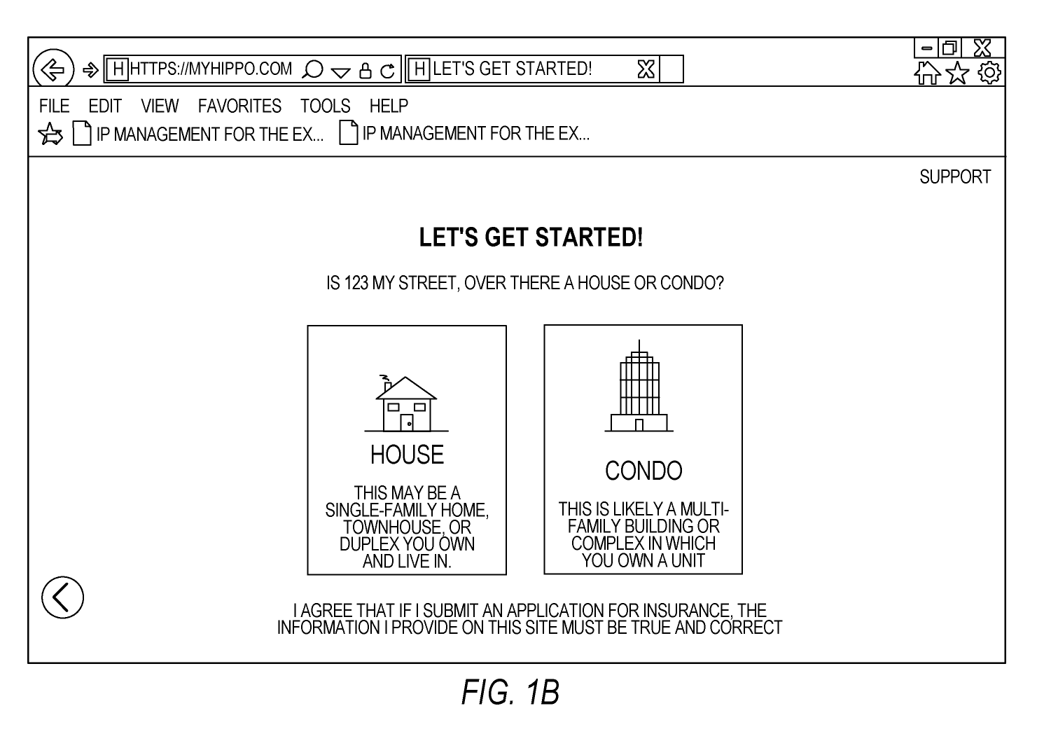

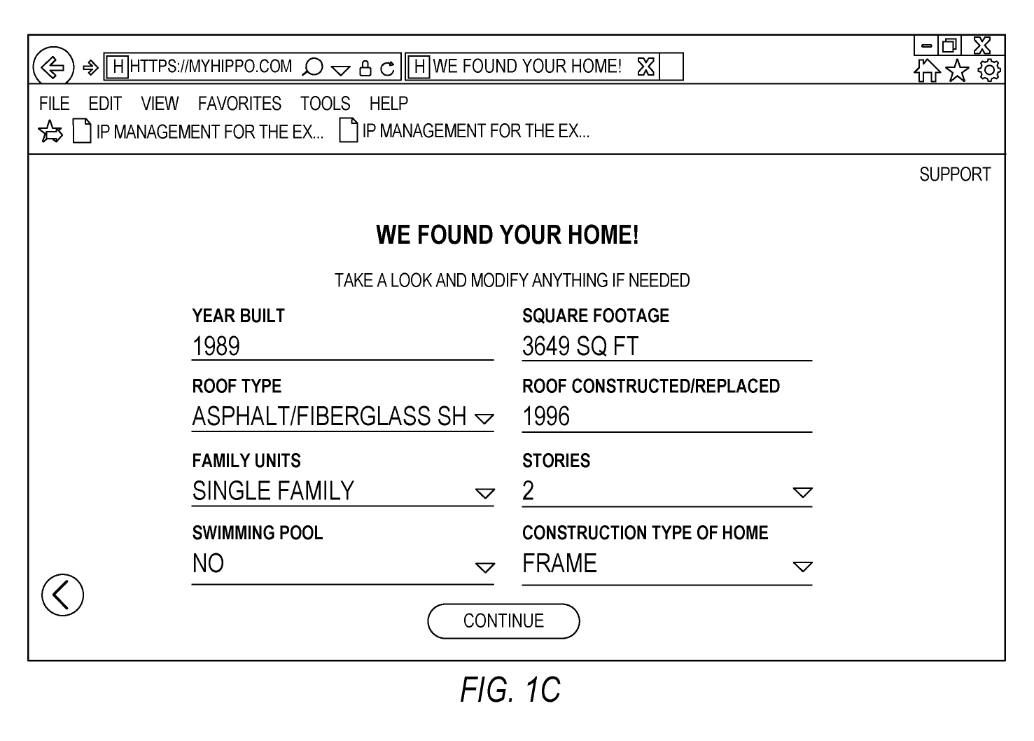

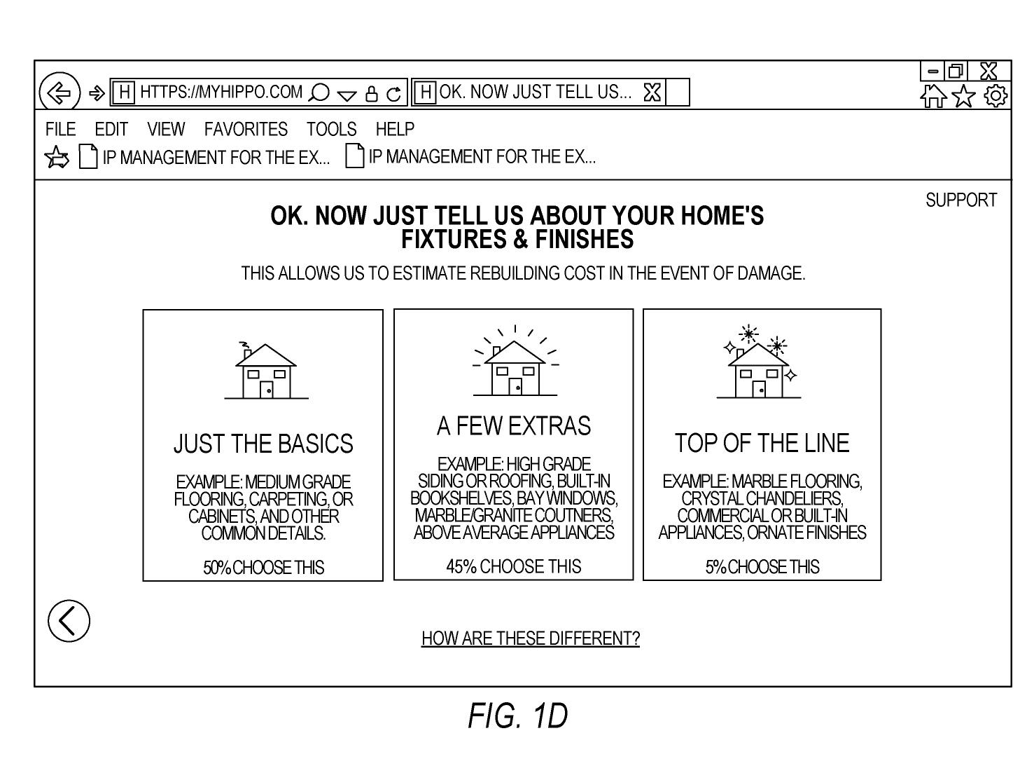

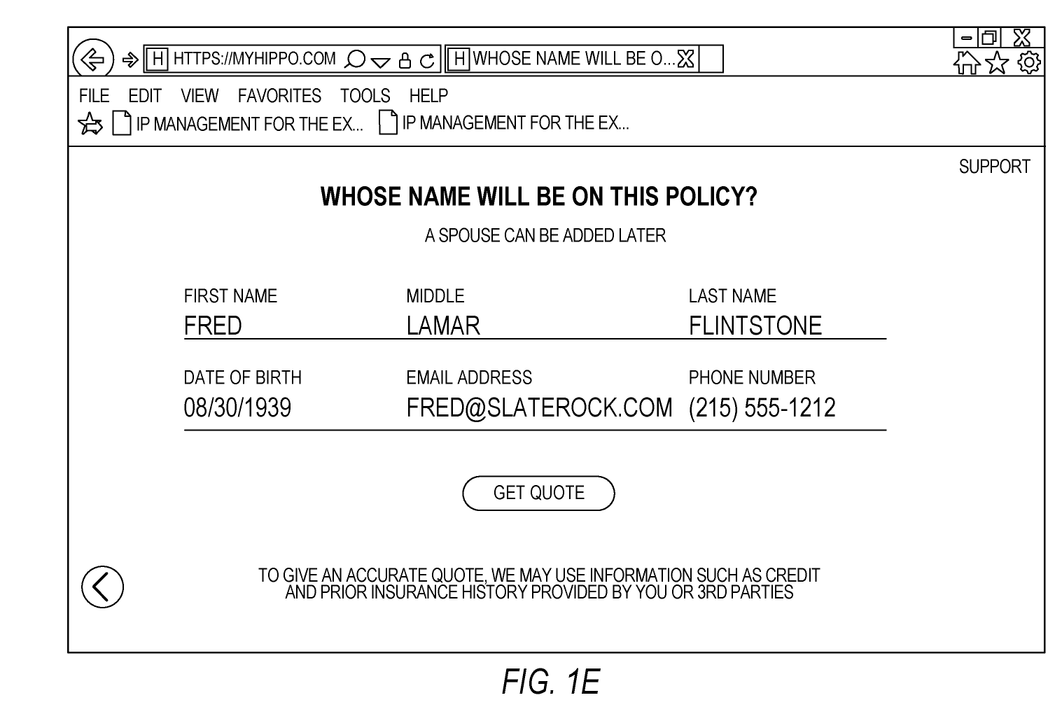

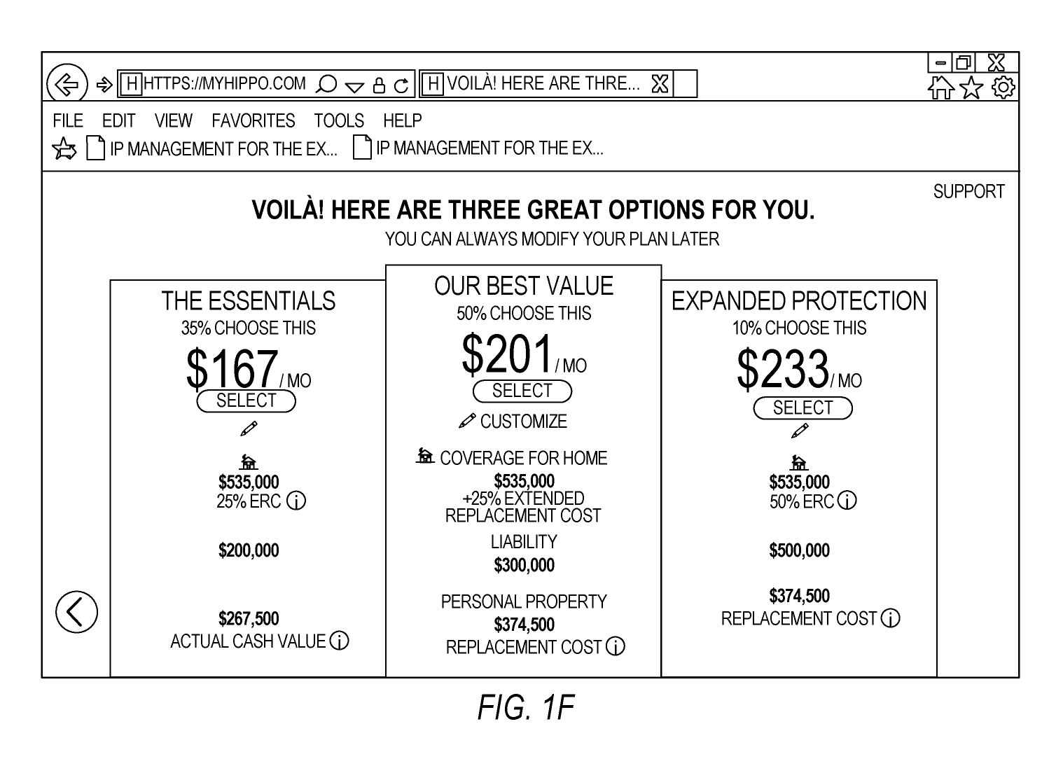

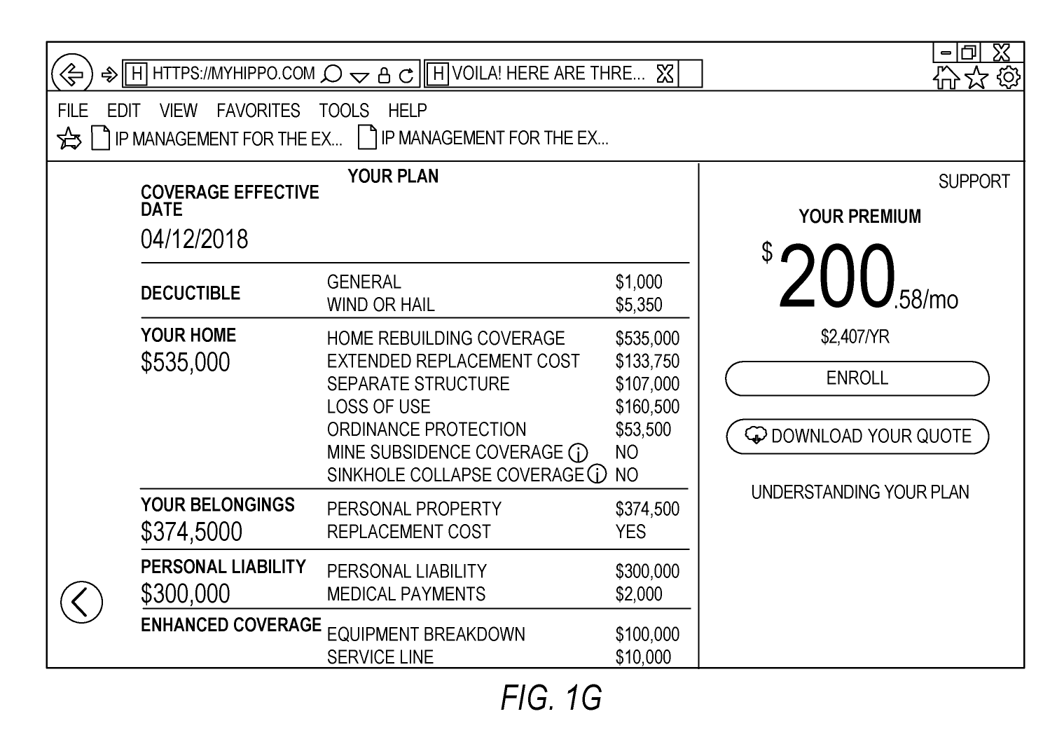

The following description with respect to FIGS. 1-10 sufficiently illustrates specific embodiments to enable those skilled in the art to practice them. Other embodiments may incorporate structural, logical, process, and other changes. Portions and features of some embodiments may be included in, or substituted for, those of other embodiments. Embodiments set forth in the claims encompass all available equivalents of those claims.

In order to automate the process of completing customer surveys to collect information for use in obtaining insurance or loan quotes and the like, information is gathered from the potential customer that can be used to obtain information related to that customer and property from publicly available information sources and data vendors to pre-fill the customer survey. However, the information available about customers and property is not in a standard format amongst information sources and thus cannot be readily compared for validation and conflict resolution. The information gathered from the information sources needs to be standardized for validation and comparison to resolve any conflicts among the gathered information. Also, to improve the customer experience, this process needs to be completed in real-time or near real-time.

FIGS. 1A-1G illustrate graphical user interfaces in accordance with sample embodiments for collecting information from a potential customer and generating a pre-filled survey in minutes or even seconds. In the example of FIGS. 1A-1G, the pre-filled survey is used in the process of obtaining an insurance quote. It will be appreciated that the pre-filled customer survey also may be used for loan applications and other transactions for which information must first be gathered from the potential customer. As illustrated in FIG. 1A, a potential customer for home insurance is asked to provide information related to that customer and property for use in accessing publicly available information sources and data vendors for information to pre-fill the customer survey. In this example, the potential customer provides the address of the home to be insured. Once the address has been provided, the customer is asked to select the type of home, as illustrated in the graphical user interface illustrated in FIG. 1B. The address is stored so that it is unnecessary to refetch the address data. Using the processes described in more detail below, this information is used to acquire property information about the home for presentation in a pre-fill template as illustrated in FIG. 1C. In this example, the pre-fill template includes property information about the home such as year built, square footage, roof type, year roof constructed/replaced, family units, stories, whether there is a swimming pool, and construction type of home. Of course, these are only samples; other types of property information may be gathered and presented as desired.

Once the basic property information has been obtained and pre-filled into the template, the potential customer is typically given the opportunity to change incorrect information, as appropriate. The potential customer is then asked to provide information about the fixtures and finishes in the home that is to be covered by the home insurance. To maintain the ease and speed of the process, the potential customer is typically asked to select a category for the fixtures and finishes as illustrated in FIG. 1D. Of course, the customer may be asked additional questions about the fixtures and finishes. Also, if such information is available from information sources, the home address and customer information may be used to obtain additional pre-fill information about the fixtures and finishes as may be available from public information sources and private data vendors.

Once the information about the home and the home's fixtures and finishes have been obtained, basic information about the potential customer is requested as illustrated in FIG. 1E. This customer information may be used, in turn, to obtain additional information about the customer and/or the home such as, for example, whether any insurance claims have been made against the home as well as the financial history, insurance claims, and/or credit status of the potential customer, provided the customer approves access to such information. The customer information and property information is then used along with insurance data tables to obtain the information required to generate an insurance quote for the home.

FIG. 1F illustrates a graphical user interface for presenting sample quotes to the potential customer based on the customer information and pre-filled property information so obtained. In a sample embodiment, the potential customer is presented with policy options setting forth ranges of insurance features at different price points for selection. Upon selection of one of the options, a detailed quote is presented via the potential customer's graphical user interface as illustrated in FIG. 1G. The detailed quote may include an estimate of the cost to rebuild the home as well as other standard home insurance services.

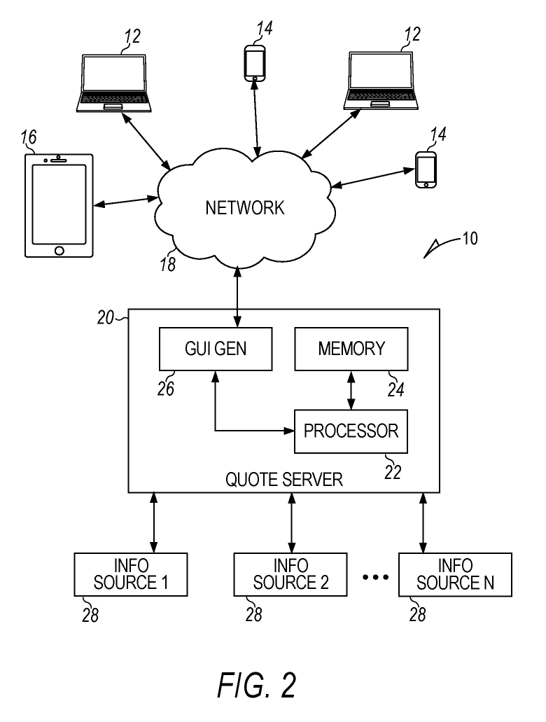

In accordance with sample embodiments, the entire process illustrated in FIG. 1 may be performed in a couple of minutes or less. It will be appreciated by those skilled in the art that the illustrated process has the benefit of reduced human error, improved data consistency, and increased speed as the need for human lookup of information is significantly reduced. The applicant need not lookup the information but merely validate the accuracy of the information in the pre-filled forms that is inserted from the online information sources. How this is accomplished is described in more detail below with respect to FIGS. 2-10.

FIG. 2 illustrates the architecture of an electronic communications platform 10 that pre-fills property and personal information into loan applications in accordance with a sample embodiment. As illustrated in FIG. 2, the electronic communications platform 10 is set up in a client server arrangement where potential customers communicate via their client devices and network 18 with quote server 20. The client device may comprise, but is not limited to, a mobile phone 12, desktop computer 14, or other communication device 16 including, for example, a laptop, portable digital assistant (PDA), smart phone, tablet, ultra-book, netbook, multi-processor system, microprocessor-based or programmable consumer electronic, or any other communication device that a user may utilize to access the quote server 20. In some embodiments, the client device 12, 14, 16 may comprise a display module (not shown) to display information (e.g., in the form of user interfaces). In further embodiments, the client device 12, 14, 16 may comprise one or more of touch screens, accelerometers, gyroscopes, cameras, microphones, global positioning system (GPS) devices, and so forth. The network 18 may be an ad hoc network, an intranet, an extranet, a virtual private network (VPN), a local area network (LAN), a wireless LAN (WLAN), a WAN, a wireless WAN (WWAN), a metropolitan area network (MAN), a portion of the Internet, a portion of the Public Switched Telephone Network (PSTN), a cellular telephone network, a wireless network, a Wi-Fi network, a WiMAX network, another type of network, or a combination of two or more such networks. Also, the user of the client device 12, 14, 16 may be a person, a machine, or other means of interacting with the client device 12, 14, 16. In various embodiments, the user is not part of the communications platform 10, but is a potential customer that is interacting with the communications platform 10 via the client device 12, 14, 16 or another means.

The client device 12, 14, 16 may include one or more applications (also referred to as “apps”) such as, but not limited to, a web browser, messaging application, electronic mail (email) application, an online access client, and the like. In some embodiments, if an online access client is included in the client device 12, 14, 16, then this application is configured to locally provide the user interface and at least some of the functionalities with the application configured to communicate with the communications platform 10, on an as needed basis, for data and/or processing capabilities not locally available. Conversely if the online access client is not included in the client device 12, 14, 16, the client device 12, 14, 16 may use its web browser to access the initialization and/or search functionalities of the communications platform 10.

In use, the user provides input (e.g., touch screen input or alphanumeric input) to the client device 12, 14, 16 and the input is communicated to the client-server-based communications platform 10 via the network 18. In this instance, the communications platform 10, in response to receiving the input from the user, communicates information to the client device 12, 14, 16 via the network 18 to be presented to the user. In this way, the user can interact with the communications platform 10 using the client device 12, 14, 16. Further, while the communications platform 10 shown in FIG. 2 employs a client-server architecture, the present subject matter is of course not limited to such an architecture, and could equally well find application in a distributed, or peer-to-peer, architecture system, for example.

As illustrated in FIG. 2, the quote server 20 includes one or more processors 22 for executing instructions provided by instruction memory 24 for implementing the processes described herein. The quote server 20 also includes a graphical user interface (GUI) generator 26 controlled by processor(s) 22 to generate GUIs of the type illustrated in FIG. 1, for example, for sending data over the network 18 to the customer communication devices 12, 14, 16. As explained in more detail below, the processor(s) 22 implement processes for obtaining pre-fill information from information sources 28.

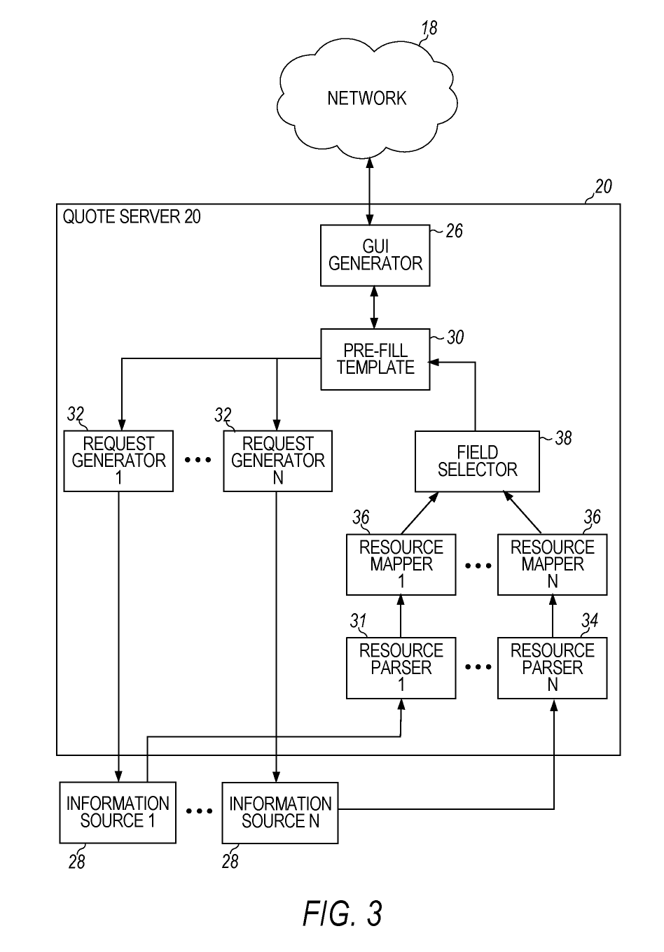

FIG. 3 illustrates a sample architecture for software processes of the quote server 20 of the communications platform of FIG. 2 in a sample embodiment. As illustrated, the processor(s) 22 process instructions from instruction memory 24 to implement software processes including graphical user interface (GUI) generator 26, pre-fill template 30, a request generator 32 for each information source 28, a response parser 34 for each information source 28, response mapper 36 for each information source 28, and field selector 38. As explained below, software processes 32-38 work together to acquire person and property information from a parallel pool of available information sources 28 for automatically populating the fields of pre-fill template 30 for presentation to the potential customer via a GUI generated by GUI generator 26. For the example of obtaining property information for completion of a home insurance quote, the information sources 28 may include real estate listings and satellite imagery sources for checking information, as well as conventional financial and governmental information sources. Preferably, multiple information sources 28 for the same kind of information are provided for accuracy and coverage. As noted above, pre-filling the template 30 from online information sources 28 reduces human error, improves data consistency, and increases speed of completing the customer survey as the need for human lookup of information is significantly reduced.

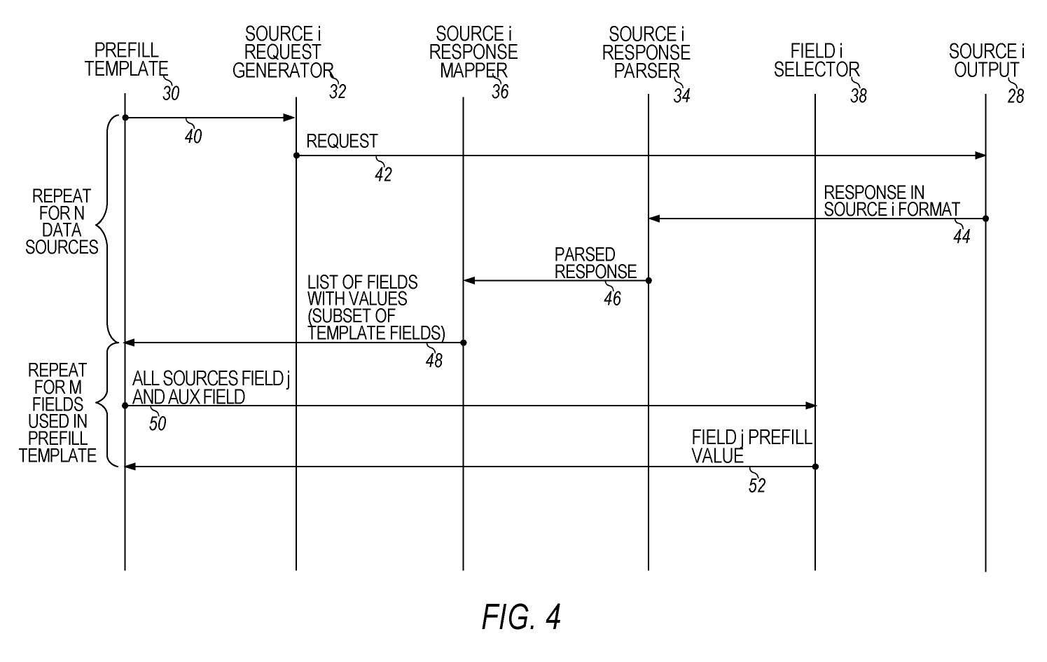

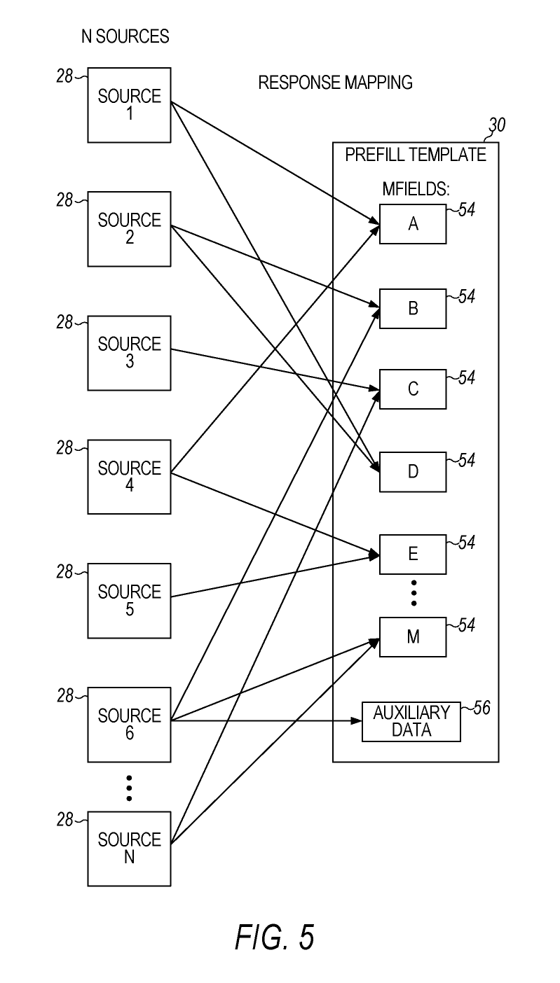

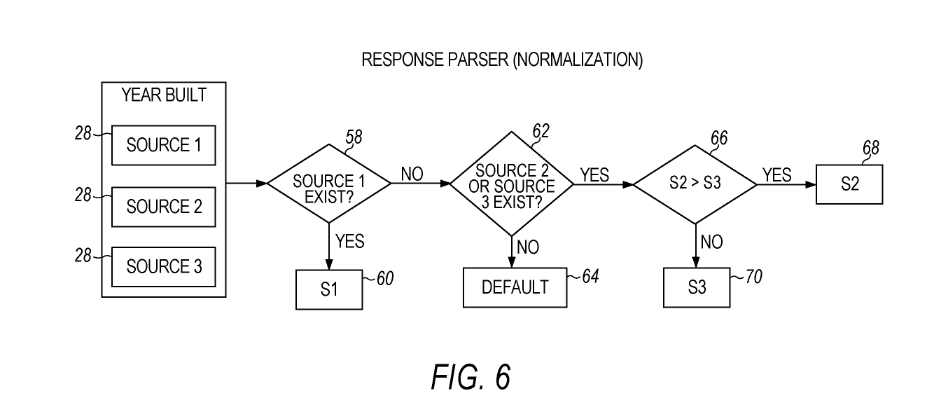

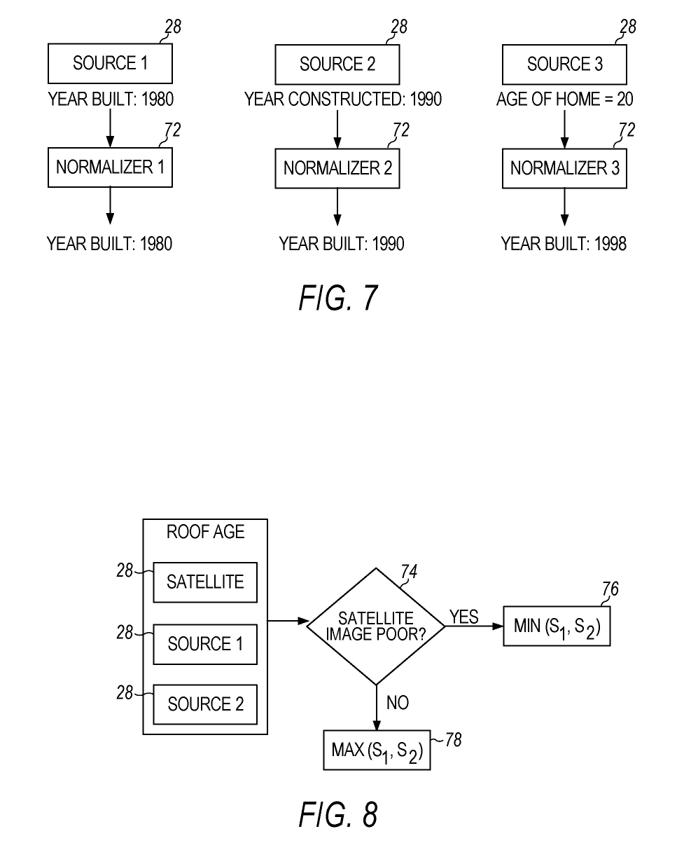

FIG. 4 illustrates a timing diagram showing the operation of the respective software components of the quote server in a sample embodiment. As illustrated, upon the user initiating the customer survey process (e.g., by selecting a type of home in FIG. 11), the pre-fill template 30 is initiated which, in turn, initiates the corresponding request generator(s) 32 at 40 to request information from the corresponding information source(s) 28 by sending requests i=1 through N (42) to the respective information sources 1 through N (28) as appropriate to complete the pre-fill template 30. The request generators 32 are built to comply with the documentation of the respective information sources 28 and sends the requests in the format (e.g., Extensible Markup Language (XML)) expected by each information source 28. The request generators 32 thus save the user from having to initiate communications with each of the respective information sources 28. Each respective information source 28 responds to the request by providing a report in its native data format at 44. The respective responses 44 from each information source 28 are provided to the corresponding response parser 34 which is also built to comply with the documentation of the respective information source 28, and the received data is normalized into a common format for loading into the pre-fill template 30 as described, for example, with respect to FIGS. 6 and 7. The response parser 34 thus interprets and sorts the received information without requiring user input. The parsed (normalized) responses 46 are provided to the corresponding response mapper 36 for mapping data received from the respective information sources 28 to respective data fields of the pre-fill template 30 as described below with respect to FIG. 5. This automation of the mapping function greatly accelerates the response process without requiring further user input. The mapped data is then provided as a list of data fields with information values from the information sources 28 at 48 for inclusion in the respective data fields of the pre-fill template 30.

It will be appreciated that certain data fields may receive data from multiple information sources 28, which may lead to data conflict if the received data has inconsistent values. Indeed, this feature enables the disclosed system to sample multiple information sources for increased accuracy and to select the best information available. Thus, the field selector 38 compares the received data to identify such data conflicts where the data values are inconsistent. Upon detection of inconsistent data values for respective data fields, field selector 38 resolves the data conflicts based on predetermined business rules as described by way of example with respect to FIG. 8. The selection logic based on the business rules is manually developed by humans based on research, logic, limitations, anecdotal evidence, etc. to identify the best and most trustworthy data available. The data value for the selected information source 28 is provided to the pre-fill template 30 to update the data value for the corresponding data field in the pre-fill template 30.

As further illustrated in FIG. 4, the pre-fill template 30 may also ask the field selector 38 at 50 to forward auxiliary images for storage in the pre-fill template 30 as backup information for the information provided in the pre-fill template 30. The backup information is provided to the pre-fill template 30 at 52, if available. For example, satellite image data may be stored in the pre-fill template 30 with the selected data values from the selected information source 28 but the satellite image data is not necessarily made available to the potential customer via the GUI with the other pre-fill data in the pre-fill template 30.

FIG. 5 illustrates the mapping by response mapper 36 of responses from information sources 28 to the pre-fill template 30 in a sample embodiment. As illustrated, the data from the respective information sources 28 may have relevance to one or more of the data fields 54 in the pre-fill template 30 and mapped to the data fields 54 in a one-to-one or one-to-many configuration. In sample embodiments, the relevance of the data of a particular information source 28 to a particular data field 54 is determined in advance by the proprietor of the quote server 20 and mapped to the appropriate data field(s) 54. The mapping may be performed by assigning addresses, flags, or pointers to the data values from the respective information sources 28 or by other techniques well-known to those skilled in the art. Also, as appropriate, the data from the information sources 28 may be mapped to auxiliary data field 56 in support of the data values provided to the respective data fields 54 by that information source 28.

As noted above, the response parser 34 functions to normalize the data received from the respective information sources 28 into a common format for loading into the pre-fill template 30. FIG. 6 illustrates an example of the operation of the response parser 34 for identifying information to use to establish the year a home was built in a sample embodiment. In the example illustrated in FIG. 6, three different information sources 28 may have information relevant to the year that the identified home was built. The response parser 34 has established business rules that cross-reference the information sources 28 based on research and anecdotal evidence establishing which information source 28 is most accurate and thus the information source 28 to select in different circumstances. The business rules are manually created and applied to the respective information sources 28 dependent upon the types of information provided by the respective information sources 28. In this example, source 1 has priority over the other sources, so if data values are provided by source 1, it is determined at 58 that the data values from source 1 should be provided to the pre-fill template at 60. However, if no data values are provided by source 1, it is determined at 62 whether any data values have been provided by source 2 or source 3. If no data values have been provided by source 2 or source 3, then a default value for the year built is provided at 64. For example, an average or median value for the relevant zip code may be obtained from an information source 28 and used in place of a particular value for that property. If data values have been provided by source 2 or source 3, then the data values are compared at 66 to determine which data values to use. In this example, if the data values from source 2 are greater than source 3, then the data values for source 2 are provided to the pre-fill template 30 at 68. Otherwise, the data values for source 3 are provided to the pre-fill template 30 at 70. The response parser 34 may also use logic regarding how information from one or more information sources 28 is to be combined as well as logic identifying what information to use when the data values from the information sources 28 conflict. Generally speaking, this logic may be established in advance by studying the type of data provided by the respective sources 28 including its reliability, timeliness, format, and the like and making determinations as to when such information should be used when compared with other similar information sources 28. The determinations are then implemented as business rules such as: use source 1 when X is true; otherwise, use source 2, and the like.

The response parser 34 also normalizes the data formats of the data from the different information sources 28 for insertion into the pre-fill template 30 in a sample embodiment. For example, data values from source 1 may be in XML format or a Portable Document Format (PDF) while the pre-fill template 30 is expecting data values in a JavaScript Object Notation (JSON) format. In such cases, the response parser 34 uses, for example, readily available open source conversion routines to remove the data responsive to the request and to convert the received data from, for example, XML data to JSON data and, as appropriate, to automatically convert the PDF data to JSON data in the same format as locally generated data.

As illustrated in FIG. 7, the response parser 34 also normalizes the received data values into a common presentation format. For example, the year built data provided by the respective information sources 28 may be provided in different formats that need normalization. In the example of FIG. 7, the year built data from source 1 is in the format Year_built: 1980, while the year built data from source 2 is in the format YearConstructed: 1990, and the year built data from source 3 is in the format AgeofHome=20. Normalizers 72 are preprogrammed to parse the data and to change the data into a common format, in this example. Year_built: [data value] where [data value]=1980, 1990, and 1998 for the respective information sources 28. Since in this case the year built values are all different, it will be appreciated that the pre-fill template 30 will detect that the data values provided by the different information sources 28 are in conflict and that the conflict in the data values will need to be resolved by selecting one of the information sources 28, averaging the values, or performing some other function on the respective data values as appropriate.

FIG. 8 illustrates an example of the operation of the field selector 38 in selecting an information source 28 to resolve a data conflict in a sample embodiment. The field selector 38 generally uses preloaded logic to resolve conflicts. In this example, the information sources 1 and 2 have provided inconsistent information relating to the age of the roof of the home. In this example, satellite image data is called upon to resolve the data conflict by providing evidence of the material of the roof within a confidence threshold that the information is accurate. Such information may be determined in advance based on the quality of the resource, in this example, the roof quality as determined by a satellite image, which is then incorporated into a business rule. If the satellite image indicates that the roof quality is poor (or no satellite image) for the particular home at 74, then the older roof age is assumed at 76. However, if the satellite image indicates that the roof quality is good for the particular home at 74, then the more recent roof age is assumed at 78. The selected roof age value is then provided to the pre-fill template 30 in the common format expected by pre-fill template 30. Of course, a simple average of the two roof age values could be taken, a default age could be assigned, or a value could be calculated from available inputs. Also, if the roof age values are significantly different, the roof age value could be flagged for check by the potential customer when the pre-fill template is presented and could also be flagged for follow-up before an insurance or loan policy is issued. In sample embodiments, the satellite image of the roof is stored in the auxiliary data field 56 of the pre-fill template 30 to corroborate the age of the roof. In other embodiments, the roof image may be analyzed using imaging software to calculate an age of the roof.

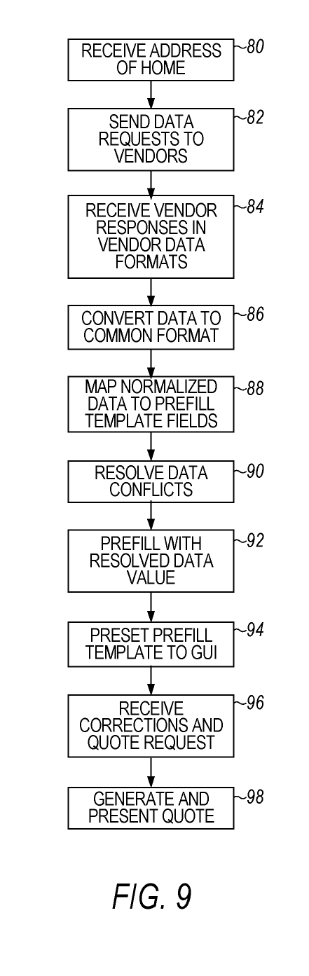

FIG. 9 is a flow diagram illustrating sample operation of the quote server 20 in a sample embodiment. As illustrated, the quote server 20 receives the address of the property at 80 in the case of a home to start the pre-fill process. Of course, if the property is an automobile, then a vehicle identification number may be provided instead. Similarly, if the property is some other form of personal property, then a product identification for the other form of personal property would be provided. The pre-fill template 30 then causes request generator 32 to issue a request at 82 for data from information vendors 28 or from internal information sources 28 available to the proprietor of the quote server 20. The requested data from the information sources 28 is obtained at 84 in a few seconds and provided to the quote server 20 in the format of the information source 28 from which the information is provided. The response parser 34 then normalizes the data into a common format at 86 for storage in the pre-fill template 30 as described above. Then, at 88, the normalized data is mapped to the pre-fill template fields 54 by response mapper 364 as described above with respect to FIG. 5.

If the pre-fill template 30 receives data values in a particular field 54 from more than one information source 28 and the data values differ, then the data conflict is resolved at 90. As noted above with respect to FIG. 8, this task is performed by field selector 38 by implementing preestablished business rules that enable the system to automatically select data values from one information source 28 over another. As noted above, this process enables multiple information sources to be used and may be as simple as prioritizing one information source 28 over another or may be a function of the data values or conditionally based on other considerations as in the example of FIG. 8. Once the data conflict has been resolved, the data values from the selected information source 28 are provided at 92 to the pre-fill template 30 to update the data values in the corresponding data field 54. The updated pre-fill template 30 is then provided to the potential customer via the GUI generated by GUI generator 26 at 94. In sample embodiments, the time from initiating the pre-fill operation to receiving the pre-filled customer survey is a few (e.g., five) seconds. The quote server 20 then waits for a response from the potential customer. The potential customer may provide corrections to the pre-filled data in the pre-fill template 30, approve the data, and/or may request a quote based on the presented data at 96. The quote server 20 then accesses the insurance or loan data tables to perform coverage calculations and to generate and present a quote at 98 based on the customer corrected information provided in the pre-fill template 30. The resulting process enables the quote server 20 to make real-time decisions about which information sources 28 to use in different situations and to enable the potential customer to obtain an accurate quote in a very short period of time with an improved customer experience.

In this manner, the disclosed systems and methods reduce human error, improve data consistency, and increase speed as the need for human lookup of information in completing a customer survey is significantly reduced. The applicant need not lookup the information but merely validate the accuracy of the information in the pre-filled forms that is inserted from the online information sources. As customer surveys are common components of insurance applications, loan applications, applications for club memberships, and other online applications, the systems and methods described herein provide solutions rooted in computer technology to provide benefits unique to computer networks to enhance the user's experiences in the online environment.

### Modules, Components, and Logic

Certain embodiments are described herein as including software or logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a FPGA or an ASIC. A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” or “hardware processor” as used herein should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API).

The performance of certain of the operations may be distributed among the processors, not only residing within a single machine, but deployed across a number of machines. In some example embodiments, the processors or processor-implemented modules may be located in a single geographic location (e.g. within a home environment, an office environment, or a server farm). In other example embodiments, the processors or processor-implemented modules may be distributed across a number of geographic locations.

### Machine and Software Architecture

The modules, methods, applications and so forth described in conjunction with FIGS. 1-9 are implemented in some embodiments in the context of a machine and an associated software architecture. The sections below describe a representative architecture that is suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things” while yet another combination produces a server computer for use within a cloud computing architecture. Not all combinations of such software and hardware architectures are presented here as those of skill in the art can readily understand how to implement the inventive subject matter in different contexts from the disclosure contained herein.

### Example Machine Architecture and Machine-Readable Medium

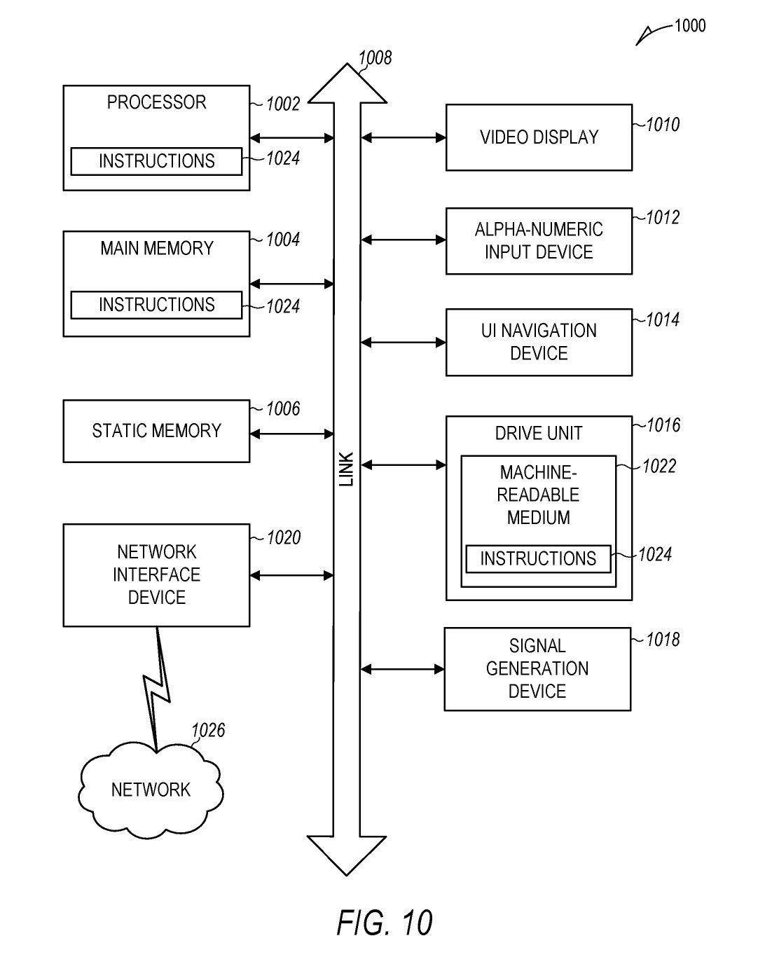

FIG. 10 is a block diagram illustrating components of a machine 1000, according to some example embodiments, able to read instructions from a machine-readable medium (e.g., a machine-readable storage medium) and perform any one or more of the methodologies discussed herein. In this example, machine 1000 may correspond to quote server 20, processor 1002 may correspond to processor 22, and instruction memory 1024 may correspond to instruction memory 24. In this example, the communications platform 10 may include more than one processor (not shown) to execute or implement one or more of the application(s)/platform(s) described herein. The one or more processors 1002 may be any type of commercially available processor, such as processors available from the Intel Corporation, Advanced Micro Devices, Texas Instruments, or other such processors. Further still, the one or more processors 1002 may include one or more special-purpose processors, such as a Field-Programmable Gate Array (FPGA) or an Application Specific Integrated Circuit (ASIC). The one or more processors 1002 may also include programmable logic or circuitry that is temporarily configured by software to perform certain operations. Thus, once configured by such software, the one or more processors become specific machines (or specific components of a machine) uniquely tailored to perform the configured functions and are no longer general-purpose processors.

The communications platform 10 may further include various storage device(s) and/or machine-readable medium(s) for storing the application(s)/platform(s) and/or the data from the user and/or the respective information sources 28. The machine-readable medium includes one or more devices configured to store instructions and data temporarily or permanently and may include, but not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store the application(s)/platform(s) and the data from the user and/or the respective information sources 28. Accordingly, the machine-readable medium may be implemented as a single storage apparatus or device, or, alternatively and/or additionally, as “cloud-based” storage systems or storage networks that include multiple storage apparatus or devices.

In one embodiment, the application(s)/platform(s) are written in a computer-programming and/or scripting language. Examples of such languages include, but are not limited to, C, C++, C#, Java, JavaScript, Perl, Python, or any other computer programming and/or scripting language now known or later developed. Also, the GUI generator 26 is configured to present one or more GUIs to the client device 12, 14, 16 for interacting with the communications platform 10.

Specifically, FIG. 10 shows a diagrammatic representation of the machine 1000 in the example form of a computer system, within which instructions 1024 (e.g., software, a program, an application, an applet, an app, or other executable code) for causing the machine 1000 to perform any one or more of the methodologies discussed herein may be executed. For example, the instructions 1024 may cause the machine 1000 to execute the flow diagrams of FIGS. 4 and 9. Additionally, or alternatively, the instructions 1024 may implement one or more of the components of FIG. 3 and FIGS. 5-8. The instructions 1024 transform the general, non-programmed machine 1000 into a special purpose machine 1000 programmed to carry out the described and illustrated functions in the manner described. In alternative embodiments, the machine 1000 operates as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a personal computer (PC), a tablet computer, a laptop computer, a netbook, a PDA, or any machine capable of executing the instructions 1024, sequentially or otherwise, that specify actions to be taken by machine 1000. Further, while only a single machine 1000 is illustrated, the term “machine” shall also be taken to include a collection of machines 1000 that individually or jointly execute the instructions 1024 to perform any one or more of the methodologies discussed herein.

The machine 1000 may include processors 1002, main memory/storage 1004, 1006, and I/O components 1020, which may be configured to communicate with each other such via a bus 1008. In an example embodiment, the processors 1002 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may execute the instructions 1024. The term “processor” is intended to include multi-core processor that may comprise two or more independent processors (sometimes referred to as “cores”) that may execute instructions 1024 contemporaneously. The machine 1000 also may include a single processor with a single core, a single processor with multiple cores (e.g., a multi-core process), multiple processors with a single core, multiple processors with multiples cores, or any combination thereof.

The memory/storage 1004, 1006 may include a memory such as a main memory 1004, or other memory storage, and a static memory 1006, both accessible to the processors 1002 via the bus 1008. The main memory 1004 stores the instructions 1024 embodying any one or more of the methodologies or functions described herein. The instructions 1024 may also reside, completely or partially, within the memory 1006, within the drive unit 1016, within at least one of the processors 1002 (e.g., within the processor's cache memory), or any suitable combination thereof, during execution thereof by the machine 1000. Accordingly, the memory 1006, the drive unit 1016, and the memory of processors 1002 are examples of machine-readable media.

As used herein, “machine-readable medium” means a device able to store instructions 1024 and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 1024. The term “machine-readable medium” shall also be taken to include any medium, or combination of multiple media, that is capable of storing instructions (e.g., instructions 1024) for execution by a machine (e.g., machine 1000), such that the instructions, when executed by one or more processors of the machine 1000 (e.g., processors 1002), cause the machine 1000 to perform any one or more of the methodologies described herein. Accordingly, a “machine-readable medium” refers to a single storage apparatus or device 1022, as well as “cloud-based” storage systems or storage networks that include multiple storage apparatus or devices. The term “machine-readable medium” excludes signals per se.

The input/output (I/O) components 1010, 1012 may include a wide variety of components to receive input, provide output, produce output, transmit information, exchange information, capture measurements, and so on. The specific I/O components 1010, 1012 that are included in a particular machine will depend on the type of machine. For example, portable machines such as mobile phones will likely include a touch input device or other such input mechanisms, while a headless server machine will likely not include such a touch input device. It will be appreciated that the I/O components 1010, 1012 may include many other components that are not shown in FIG. 10. The I/O components 1010, 1012 are grouped according to functionality merely for simplifying the following discussion and the grouping is in no way limiting. In various example embodiments, the I/O components 1010, 1012 may include output components 1010 and input components 1012. The output components 1010 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1012 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 1010, 1012 may include biometric components, motion components, environmental components, or position components among a wide array of other components. For example, the biometric components may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components may include acceleration sensor components (e.g., accelerometer), gravitation sensor components, rotation sensor components (e.g., gyroscope), and so forth. The environmental components may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1018, 1020 may include communication components operable to couple the machine 1000 to a network 1026 (which may be network 18) or external devices via appropriate coupling (not shown). For example, the communication components 1018, 1020 may include a network interface component 1020 or other suitable device such a signal generator 1018 to interface with the network 1026. In further examples, communication components 1018, 1020 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The external devices may be another machine or any of a wide variety of peripheral devices (e.g., a peripheral device coupled via a USB).

Moreover, the communication components 1018, 1020 may detect identifiers or include components operable to detect identifiers. For example, the communication components 1018, 1020 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF, Ultra Code, UCC RSS-2D bar code, and other optical codes), or acoustic detection components (e.g., microphones to identify tagged audio signals). In addition, a variety of information may be derived via the communication components 1018, 1020, such as location via Internet Protocol (IP) geo-location, location via Wi-Fi® signal triangulation, location via detecting a NFC beacon signal that may indicate a particular location, and so forth. UI navigation devices 1014 may also be provided as appropriate for the particular application.

### Transmission Medium

In various example embodiments, one or more portions of the network 1026 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 1026 or a portion of the network 1026 may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1×RTI), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 1024 may be transmitted or received over the network 1026 using a transmission medium via a network interface device (e.g., a network interface component included in the communication components 1018, 1020) and utilizing any one of a number of well-known transfer protocols (e.g., hypertext transfer protocol (HTTP)). Similarly, the instructions 1024 may be transmitted or received using a transmission medium via the coupling (e.g., a peer-to-peer coupling) to external devices. The term “transmission medium” shall be taken to include any intangible medium that is capable of storing, encoding, or carrying instructions 1024 for execution by the machine 1000, and includes digital or analog communications signals or other intangible medium to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated or by the particular elements identified. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

### Numbered Examples

Certain embodiments are described herein as numbered examples 1, 2, 3, etc. These numbered examples are provided as examples only and do not limit the subject technology.

Example 1 is system comprising a machine-readable medium storing computer-executable instructions and_at least one hardware processor communicatively coupled to the machine-readable medium that, when the computer-executable instructions are executed, configures the system to pre-fill the information needed for completing a customer survey in connection with requested products and services by receiving identifying information for property; using the property identifying information to request additional data about the property from at least one source of property information; receiving at least one response to the request for additional data about the property from the at least one source of property information; normalizing data received in the at least one response to a predetermined data format; mapping the normalized data to predetermined fields of a pre-fill template; and generating a graphical user interface including the updated pre-fill template for presentation to a user's display device as at least part of the customer survey.

Example 2 is a system as in Example 1 wherein the at least one hardware processor further executes computer-executable instructions to resolve data conflicts in data received from at least two information sources using preestablished business rules determining which information source has priority in the event of a conflict and to provide data to the pre-fill template from an information source having priority.

Example 3 is a system as in Example 2 wherein the at least one hardware processor further executes computer-executable instructions to receive user corrections to data in the updated pre-fill template presented via the graphical user interface and to generate a quote for a product or service using corrected data in the updated pre-fill template.

Example 4 is a system as in Example 1 wherein the identifying information comprises at least one of an address of a home and a vehicle identification number.

Example 5 is a system as in Example 1 wherein requesting additional data about the property comprises requesting data from at least two sources of property information in parallel and automatically selecting data to provide in the pre-fill template from the at least two sources of property information using preestablished business rules applied to the at least two sources of property information.

Example 6 is a system as in Example 1 wherein the at least one hardware processor further executes computer-executable instructions to store data from the at least one information source in the template as auxiliary data that supports data in the updated pre-fill template presented to the user's display device as at least part of the customer survey.

Example 7 is a method of pre-filling information needed for completing a customer survey in connection with requested products and services, comprising a receiving, by at least one processor, identifying information for property; using, by the at least one processor, the property identifying information to request additional data about the property from at least one source of property information; receiving, by the at least one processor, at least one response to the request for additional data about the property from the at least one source of property information; normalizing, by the at least one processor, data received in the at least one response to a predetermined data format; mapping, by the at least one processor, the normalized data to predetermined fields of a pre-fill template; and generating, by the at least one processor, a graphical user interface including the updated pre-fill template for presentation to a user's display device as at least part of the customer survey.

Example 8 is a method as in Example 7 further comprising the at least one processor resolving data conflicts in data received from at least two information sources using preestablished business rules determining which information source has priority in the event of a conflict and providing data to the pre-fill template from an information source having priority.

Example 9 is a method as in Example 8 further comprising the at least one processor receiving user corrections to data in the updated pre-fill template presented via the graphical user interface and generating a quote for a product or service using corrected data in the updated pre-fill template.

Example 10 is a method as in Example 7 wherein the identifying information comprises at least one of an address of a home and a vehicle identification number.

Example 11 is a method as in Example 7 wherein requesting additional data about the property comprises requesting data from at least two sources of property information in parallel and automatically selecting data to provide in the pre-fill template from the at least two sources of property information using preestablished business rules applied to the at least two sources of property information.

Example 12 is a method as in Example 7 further comprising the at least one processor storing data from the at least one information source in the pre-fill template as auxiliary data that supports data in the updated pre-fill template presented to the user's display device as at least part of the customer survey.

Example 13 is a machine-readable storage medium storing computer-executable instructions that, when executed by at least one processor, implements a method of pre-filling the information needed for completing a customer survey in connection with requested products and services, comprising receiving identifying information for property; using the property identifying information to request additional data about the property from at least one source of property information; receiving at least one response to the request for additional data about the property from the at least one source of property information; normalizing data received in the at least one response to a predetermined data format; mapping the normalized data to predetermined fields of a pre-fill template; and generating a graphical user interface including the updated pre-fill template for presentation to a user's display device as at least part of the customer survey.

Example 14 is a medium as in Example 13 further comprising instructions that when executed by the at least one processor implements steps of resolving data conflicts in data received from at least two information sources using preestablished business rules determining which information source has priority in the event of a conflict and providing data to the pre-fill template from an information source having priority.

Example 15 is a medium as in Example 14 further comprising instructions that when executed by the at least one processor implements steps of receiving user corrections to data in the updated pre-fill template presented via the graphical user interface and generating a quote for a product or service using corrected data in the updated pre-fill template.

Example 16 is a medium as in Example 13 wherein the identifying information comprises at least one of an address of a home and a vehicle identification number.

Example 17 is a medium as in Example 13 wherein instructions for requesting additional data about the property comprises instructions that when executed by the at least one processor implements steps of requesting data from at least two sources of property information in parallel and automatically selecting data to provide in the pre-fill template from the at least two sources of property information using preestablished business rules applied to the at least two sources of property information.

Example 18 is a medium as in Example 13 further comprising instructions that when executed by the at least one processor implements the step of storing data from the at least one information source in the pre-fill template as auxiliary data that supports data in the updated pre-fill template presented to the user's display device as at least part of the customer survey.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The systems and methods described herein are captured within the scope of the following claims. It is understood by those skilled in the art that the claims encompass specific embodiments as well as embodiments that are not specifically described herein but which may include equivalent components and steps to those described herein as well as other features and modifications that would be apparent to those skilled in the art.

1. A system comprising:
a machine-readable medium storing computer-executable instructions; and
at least one hardware processor communicatively coupled to the machine-readable medium that, when the computer-executable instructions are executed, configures the system to pre-fill the information needed for completing a customer survey in connection with requested products and services by:
receiving identifying information for property;
using the property identifying information to request additional data about the property from at least one source of property information;
receiving at least one response to the request for additional data about the property from the at least one source of property information;
normalizing data received in the at least one response to a predetermined data format;
mapping the normalized data to predetermined fields of a pre-fill template; and
generating a graphical user interface including the updated pre-fill template for presentation to a user's display device as at least part of the customer survey.

2. The system as in claim 1, wherein the at least one hardware processor further executes computer-executable instructions to resolve data conflicts in data received from at least two information sources using preestablished business rules determining which information source has priority in the event of a conflict and to provide data to the pre-fill template from an information source having priority.

3. The system as in claim 2, wherein the at least one hardware processor further executes computer-executable instructions to receive user corrections to data in the updated pre-fill template presented via the graphical user interface and to generate a quote for a product or service using corrected data in the updated pre-fill template.

4. The system as in claim 1, wherein the identifying information comprises at least one of an address of a home and a vehicle identification number.

5. The system as in claim 1, wherein requesting additional data about the property comprises requesting data from at least two sources of property information in parallel and automatically selecting data to provide in the pre-fill template from the at least two sources of property information using preestablished business rules applied to the at least two sources of property information.

6. The system as in claim 1, wherein the at least one hardware processor further executes computer-executable instructions to store data from the at least one information source in the pre-fill template as auxiliary data that supports data in the updated pre-fill template presented to the user's display device as at least part of the customer survey.

7. A method of pre-filling information needed for completing a customer survey in connection with requested products and services, comprising:
receiving, by at least one processor, identifying information for property;
using, by the at least one processor, the property identifying information to request additional data about the property from at least one source of property information;
receiving, by the at least one processor, at least one response to the request for additional data about the property from the at least one source of property information;
normalizing, by the at least one processor, data received in the at least one response to a predetermined data format;
mapping, by the at least one processor, the normalized data to predetermined fields of a pre-fill template; and
generating, by the at least one processor, a graphical user interface including the updated pre-fill template for presentation to a user's display device as at least part of the customer survey.

8. The method as in claim 7, further comprising the at least one processor resolving data conflicts in data received from at least two information sources using preestablished business rules determining which information source has priority in the event of a conflict and providing data to the pre-fill template from an information source having priority.

9. The method as in claim 8, further comprising the at least one processor receiving user corrections to data in the updated pre-fill template presented via the graphical user interface and generating a quote for a product or service using corrected data in the updated pre-fill template.

10. The method as in claim 7, wherein the identifying information comprises at least one of an address of a home and a vehicle identification number.

11. The method as in claim 7, wherein requesting additional data about the property comprises requesting data from at least two sources of property information in parallel and automatically selecting data to provide in the pre-fill template from the at least two sources of property information using preestablished business rules applied to the at least two sources of property information.

12. The method as in claim 7, further comprising the at least one processor storing data from the at least one information source in the pre-fill template as auxiliary data that supports data in the updated pre-fill template presented to the user's display device as at least part of the customer survey.

13. A machine-readable storage medium storing computer-executable instructions that, when executed by at least one processor, implements a method of pre-filling the information needed for completing a customer survey in connection with requested products and services, comprising:
receiving identifying information for property;
using the property identifying information to request additional data about the property from at least one source of property information;
receiving at least one response to the request for additional data about the property from the at least one source of property information;
normalizing data received in the at least one response to a predetermined data format;
mapping the normalized data to predetermined fields of a pre-fill template; and
generating a graphical user interface including the updated pre-fill template for presentation to a user's display device as at least part of the customer survey.

14. The medium as in claim 13, further comprising instructions that when executed by the at least one processor implements steps of resolving data conflicts in data received from at least two information sources using preestablished business rules determining which information source has priority in the event of a conflict and providing data to the pre-fill template from an information source having priority.

15. The medium as in claim 14, further comprising instructions that when executed by the at least one processor implements steps of receiving user corrections to data in the updated pre-fill template presented via the graphical user interface and generating a quote for a product or service using corrected data in the updated pre-fill template.

16. The medium as in claim 13, wherein the identifying information comprises at least one of an address of a home and a vehicle identification number.

17. The medium as in claim 13, wherein instructions for requesting additional data about the property comprises instructions that when executed by the at least one processor implements steps of requesting data from at least two sources of property information in parallel and automatically selecting data to provide in the pre-fill template from the at least two sources of property information using preestablished business rules applied to the at least two sources of property information.

18. The medium as in claim 13, further comprising instructions that when executed by the at least one processor implements the step of storing data from the at least one information source in the pre-fill template as auxiliary data that supports data in the updated pre-fill template presented to the user's display device as at least part of the customer survey.
